(19) United States
(12) Patent Application Publication
(10) Pub. No.: US 2007/0106940 A1
(43) Pub. Date: May 10, 2007

(54) Enhanced digital music methods

(76) Inventor: Arielle Angelovich, Texarkana, TX (US)

Correspondence Address: Steven Thrasher, 391 Sandhill Dr., Richardson, TX, 75080, US

(21) Appl. No.: 11/598,522

(22) Filed: Nov. 13, 2006

Related U.S. Application Data
(60) Provisional application No. 60/735,292, filed on Nov. 10, 2005.

(51) Int. Cl. G06F 3/00; G06F 9/00; G06F 17/00

(52) U.S. Cl. 715/727; 715/728

(57) ABSTRACT

A method of designating flagging a broadcast audio presentation for present or future download. The method includes receiving information sufficient to identify the audio presentation, receiving an indication from the user that the user wishes to store the information or the audio, and storing the information or audio. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### TECHNICAL FIELD OF THE INVENTION

The invention relates generally to broadcast audio, and more specifically to systems and methods for storing information associated with broadcast audio.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

Broadcast audio, as is understood in the art, includes satellite music, as well as radio, television, and other wire-based and wireless distribution means. However, storing the audio requires an inordinate amount of user attention, and some degree of technical skill. Accordingly, systems for more easily storing audio are needed.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is a block-flow diagram of one method according to the invention.

FIG. 2 is a block-flow diagram of an alternative embodiment of the invention.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for-functioning-” or “step for-functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Of course, the foregoing discussions and definitions are provided for clarification purposes and are not limiting. Words and phrases are to be given their ordinary plain meaning unless indicated otherwise.

### DESCRIPTION OF THE DRAWINGS

Consumers of music are virtually bombarded with broadcast music in the car, at public locations, at public events, or while watching television. However, the music industry has a strong aversion to allowing consumers to easily download/copy broadcast music in real time. Indeed, it could destroy the industry. Yet, there exists no convenient way to either download broadcast music to digital audio devices in real time, or even remember what a consumer might have heard for later download. Thus, sales of music would be enhanced significantly if consumers could download broadcast music immediately or flag it for future download. Thus, the invention is, in one embodiment, a method for flagging or marking broadcast music for future review or download, and in another embodiment, a method for immediately downloading broadcast music, in real time.

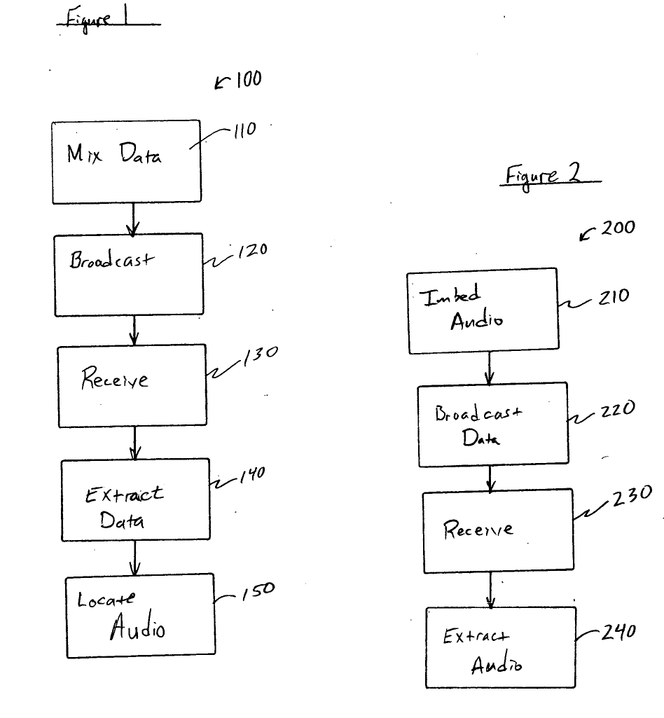

FIG. 1 is a block-flow diagram of one method 100 according to the invention, which may be embodied as an algorithm. The method 100 generally comprises blending data regarding an audio segment with the audio segment to create audible blended audio in a mix data act 110, then, in a broadcasting act 120 broadcasting the blended audio from a first device. Broadcasting may be achieved via radio, television, cable, or satellite, for example. In one embodiment, the broadcasting occurs at a concert. Sometimes, the broadcasting is only audible by a machine, and is inaudible by a human ear.

Next, in a receive act 130 the method receives the blended audio at a second device. Then, in an extract data act 140, the method extracts data from the blended audio. In one embodiment, the data is detectable in a channel separate from the audio channel. If a separate memory device independent from the second device is used to store data, then the method may store the data thereupon. Alternatively, the data may be stored locally on the second device. Then, the method associates the data with the audio segment such that the audio segment can be accessed independently of the broadcasting in a locate audio act 150. In one embodiment, a user may access a portion of the audio segment so that they can recall an audio segment they may wish to purchase. Then, a user may wish to purchase the audio segment via the purchase of a right to store the audio segment by the user commanding that the audio segment be stored, and by charging a user-account for the right to store the audio segment. Alternatively, the user may select to store the data for a later purchasing decision.

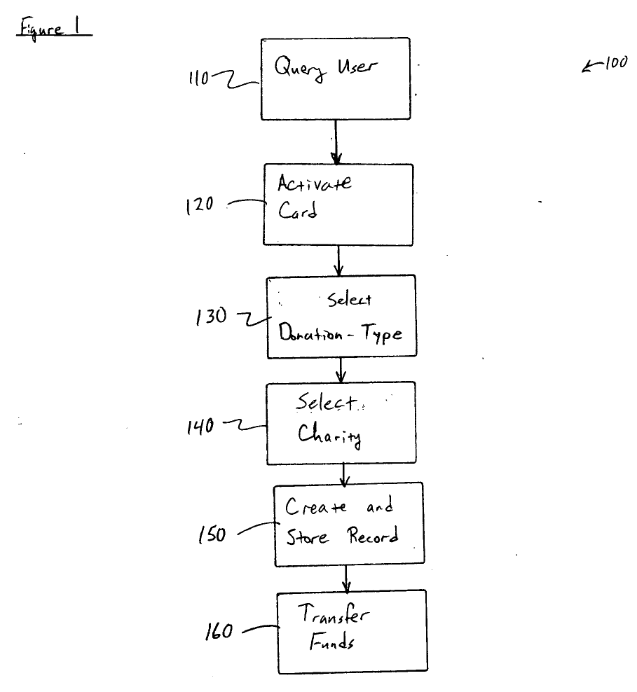

FIG. 2 is a block-flow diagram of an alternative embodiment of the invention. The alternative method 200 comprises blending an audio segment with data regarding the audio segment to create blended audio data in an imbed audio act 210. Next, the method 200 proceeds to broadcast the blended audio data from a first device in a broadcast data act 220. Then, in a receive act 230, the blended audio data is received at a second device, where the data is extracted from the blended audio data in a extract audio act 240. Afterwards, the user may purchase the right to store the audio segment, whereupon the audio segment may be extracted from the blended audio data. Alternatively, a decoding key may be provided to the user that enables the extraction of the audio segment from the blended audio data. The following description of alternative methods and variations thereof provide additional insight to the invention.

B. Flagging or Marking Music for Future Review or Download

Consumers hear broadcast music almost everywhere: such as in cars, in stores, and while watching television. Often, a consumer will hear a song they like, but can not recall the name of the song or the artist. Not being able to identify a song makes it difficult for a consumer to purchase that recording. The invention, in one embodiment, provides a convenient system and method for the consumer to record this identifying information:

1. Satellite Radio
Satellite radio is growing in popularity. Typically, satellite radio signals carry the artist and song information. Accordingly, a satellite radio signal may also carry an identifying number for the song and/or artist then being transmitted, the satellite radio signal could otherwise be configured to carry some other identifying information. This number or other information is loaded real-time into the device that receives the signal. Thus, invention involves a system for flagging (or marking) the identifying information of any song or other audio program of interest so that this data is stored for future download or review.
For example, the satellite radio receiver may be manufactured with memory and an indication device (such as a button on the receiver, or a button on a remote control device). Then, whenever the listener hears a song of interest, the listener presses the button. This causes data about the identified song to be recorded, which may include (but is not limited to) the following methodologies:
   a. The data (which includes a unique identifier, but may also include song, artist, album, genre, date and time, for example) is recorded internally in the satellite receiver's memory and can later be transmitted via a cable or wireless transmission to a portable digital device, or transmitted to any computer.
   b. The data is not recorded in the satellite receiver, but is immediately transmitted to a portable audio device where it is stored.
   c. The data is stored on a removable memory card, such as a Flash card or USB stick, for later transfer to a computer system or portable device.

Thus, when the portable digital audio device is later in communication with a user machine, such as when a portable digital audio device is docked, (including with a cradle, or wirelessly) with a computer, or when the removable memory is later inserted in the computer, any number of commercial music download services (such as iTunes™) would receive the identifying data, retrieve associated data from a database, and then identify and display the flagged songs. The consumer could then preview the songs, listen to other songs by the same artists or download the songs.

2. Radio
A similar approach applies to any broadcast radio. Many, but not all, radio stations broadcast identifying data that can be extracted from the analog signal. Some car radios and home stereos display this information. Thus, according to one embodiment of the invention, the information may be recorded as described above.
Alternatively, identifying data could be embedded in the sound recording in a manner inaudible to a person, so that when the recording is transmitted to the radio and played, an external device could decode the identifying data directly from sound recording (as opposed to the signal). This external device could be separate from the digital audio player or integrated into it. In this way, the digital audio device, when this feature is activated, could determine from the sound itself the identifying number.

3. Television
Marking or flagging of songs being broadcast on television (such as is common with digital music channels, MTV, shows (particularly those with theme songs, and the like) would occur in a similar manner as described for radio.

4. Live Events
Live bands could use the invention to market their music. At the live event, the identifying data for each song (not the song itself, but ID data) could be wireless transmitted and recorded by an external device (which may or may not be built into or integrated with the portable audio device). The consumer could then review the songs, and download those that they desire to purchase.
Additionally, the reverse of the above could be useful. Here, a device could embed the sound itself with the identifying data. The embedded “sound” would not be heard by a person while the data is broadcast, but would be decoded by an external device. This external device may be part of the portable audio player, or could be a small device designed just for this purpose. Then, following the purchase of that song, the data is unwrapped from the song so that the song can be accessed and listened to.

Therefore, this aspect of the invention, alone or in combination, allows music consumers to flag and then record the essential ID data from any music they hear during the day and then review, preview or download this music at a future time.

C. Real Time Download

An additional aspect of this invention is to provide for the real time downloading of the MP3 (or other digital files) into a portable digital device any time they are encountered.

The preferred components of this aspect of the invention may include the following:
1. A trigger component, which initiates the download, which could be internal to the portable audio device or a component of one of the devices above.
2. A download component that transmits the audio file to the portable audio device from one of the devices discussed above, which is preferably wireless.
3. A tracking component so that the ID data for each downloaded audio file is tracked with identifying customer ID data so that the customer may be billed and the payment for the music is received.
   D. Preview Downloads and Remote Downloads

Preview and remote downloads are related to the inventions above, but are also separate in the sense preview and remote download locations could be established in kiosks at book stores, at coffee stores, and other physical locations.

Preview Downloads

Digital audio players, according to one embodiment of the invention, are configured to accept preview downloads from any number of promotional locations. These could be concert venues, live music events, bookstores, or music stores, for example.
1. Preferably, the device is docked (including wirelessly) and the preview download is transmitted.
2. The download is designated as a preview, with whatever preview conditions the vendor specifies.
3. If the conditions are met (such as purchasing via iTunes within four hours), then the download becomes permanent.
4. The ID of the portable audio device can be tracked to prevent abuse of the preview downloads.
5. Preview downloads can potentially be obtained through a cell phone interface on the road.
   Remote Downloads

This is similar to preview downloads, except the final download is immediately consummated. The remote download determines the ID of the device and this is linked to account data. As soon as the download occurs, it is final and the charge occurs. This expands the ability of consumers to download music anywhere they may encounter it.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

We claim:

1. A method, comprising:
blending data regarding an audio segment with the audio segment to create audible blended audio;
broadcasting the blended audio from a first device;
receiving the blended audio at a second device;
extracting the data from the blended audio;
storing the data; and
associating the data with the audio segment such that the audio segment can be accessed independently of the broadcasting.

2. The method of claim 1 wherein the broadcasting is audible by machine only.

3. The method of claim 1 wherein the data is embedded into the audio segment such that the data itself is mechanically audible, but not audible to a human ear.

4. The method of claim 1 wherein the data is embedded into the audio segment such that the data is detectable in a channel separate from the audio channel.

5. The method of claim 1 wherein broadcasting is achieved via television.

6. The method of claim 1 wherein broadcasting is achieved via radio broadcast.

7. The method of claim 1 wherein broadcasting is achieved via cable.

8. The method of claim 1 wherein broadcasting is achieved via satellite.

9. The method of claim 1 wherein extracted data is stored locally on the second device.

10. The method of claim 1 wherein the extracted data is stored on a memory device independent from the second device.

11. The method of claim 1 wherein the broadcast is an inaudible broadcasting of data related to audio played at a concert event.

12. The method of claim 1 further comprising purchasing rights to save the audio segment.

13. The method of claim 1 wherein the blended audio includes a playable portion of the audio segment.

14. The method of claim 1 further comprising receiving a user command to store at least the data.

15. The method of claim 1 further comprising receiving a user command to store the audio segment.

16. The method of claim 15 further comprising charging a user-account for the right to store the audio segment.

17. A method, comprising:
blending an audio segment with data regarding the audio segment to create blended audio data;
broadcasting the blended audio data from a first device;
receiving the blended audio data at a second device; and
extracting the data from the blended audio data.

18. The method of claim 17 further comprising purchasing the right to store the audio segment.

19. The method of claim 17 further comprising extracting the audio segment from the blended audio data.

20. The method of claim 17 further comprising receiving a decoding key that enables the extraction of the audio segment from the blended audio data.
